(19) United States
(12) Patent Application Publication
(10) Pub. No.: US 2018/0192085 A1
(43) Pub. Date: Jul. 5, 2018

(54) METHOD AND APPARATUS FOR DISTRIBUTED VIDEO TRANSMISSION

(71) Applicant: Spotcheck Mobile Inc., Pebble Beach, CA (US)

(72) Inventors: Christopher Spanos, Stockton, CA (US); Austin D'Orsay, Pebble Beach, CA (US)

(21) Appl. No.: 15/396,234

(22) Filed: Dec. 30, 2016

(51) Int. Cl. H04N 21/238; H04L 29/08; H04N 5/77; H04N 21/234

(52) U.S. Cl. CPC H04N 21/238; H04L 67/18; H04N 21/234; H04N 5/772; H04L 67/02

(57) ABSTRACT

Visual images are transmitted to an electronic visual display device for display, by generating a video via a digital video camera positioned at a known location, transmitting the video to a computer at the same location, receiving at the computer a request for the video, and in response, obtaining a plurality of frames from the video via software executing on the computer, transmitting the frames from the computer to a server coupled to the computer via a communications network, transmitting the frames from the server to an end user computing device coupled to the server via the communications network, wherein the request for the frames is responsive to receiving input at a browser application executing on the end user device to view the known location. Finally, the frames are displayed consecutively on the display device coupled to or integrated with the end user device.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

Embodiments of the present invention relate to live streaming video across the Internet from a video camera or web camera to an end user device on demand.

### BACKGROUND

Currently, there is no actual or de facto standard among web browser applications as to the video format for receiving and displaying a live video stream, for example, obtained from an Internet connected video camera or web camera. Prior art systems and methods rely on a central server to translate the video stream into a video format acceptable to an end user device's web browser application, and then the browser application needs to include a compatible video display plug-in software component in order to play the video stream on end user's device display screen. These systems typically contemplate delivering a single video stream to a potentially large number of end users. When multiple streams need to be translated, a computational bottleneck can occur at the server. Further, owing to the computing effort to perform many video format translations, the associated costs to pay for a third party service's server computing time can become prohibitive for application service providers. What is needed is a decentralized system that handles delivery of a potentially large number of videos, each formatted according to one of any number of possible video formats, streamed from different locations, to a potentially large number of end users, in a cost effective manner.

### BRIEF DESCRIPTION OF THE DRAWINGS

Embodiments are illustrated by way of example, and not by way of limitation, and can be more fully understood with reference to the following detailed description when considered in connection with the figures in which:

FIG. 1 illustrates a system for delivering one or more of a plurality of video streams to one or more of a plurality of end user device web browser applications.

FIG. 2 illustrates a flow chart of an embodiment of the invention.

### DETAILED DESCRIPTION

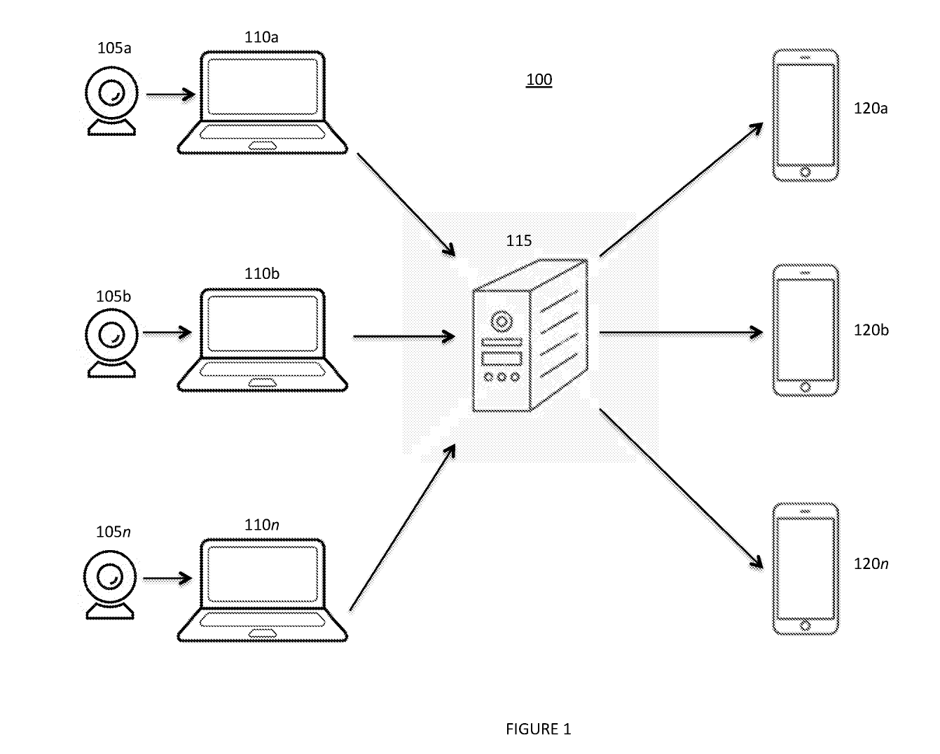

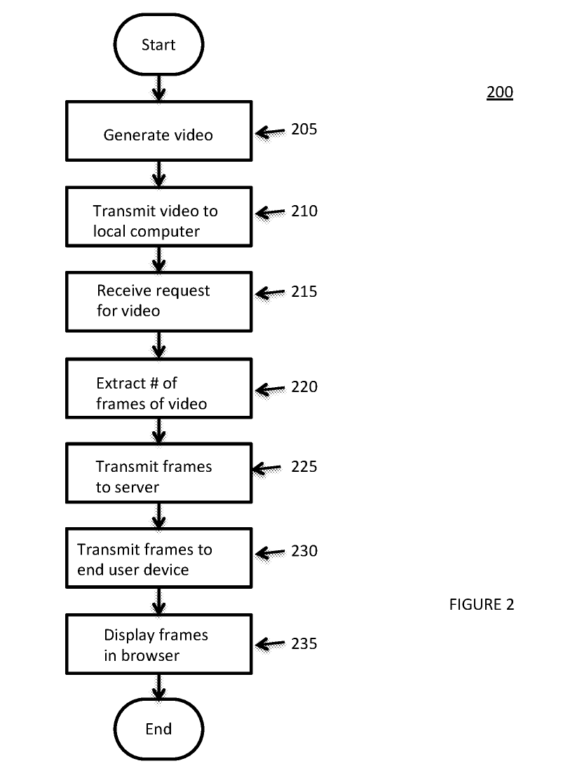

Embodiments of the present invention provide a system and method for displaying visual images transmitted electronically to an electronic visual display device. With reference to FIGS. 1 and 2, an embodiment 100/200 generates at 205 a video via a digital video camera 105a positioned at a known location, for example, a webcam located at, near, or inside, a restaurant or bar. A webcam is a video camera that feeds or streams its image, either in real time, or near real time, to or through a computer-to-computer network. In the embodiment illustrated in FIG. 1, any number of webcams 105a, 105b . . . 105n may be positioned at a corresponding number of different locations, whether restaurants, bars, other public or private venues, or event locations.

In the embodiment illustrated in FIG. 1, the webcams participate in a decentralized network, rather than a centralized network with a central network video recorder or server to handle recording, video management, and video format translation, etc. Instead, each webcam is coupled to or integrated with a local computer at or near the location of the webcam, using a local communication means, such as Wi-Fi, Ethernet, USB, etc., and the local computer handles recording, translating video format, and storing video obtained from the co-located webcam.

So, for example, in FIG. 1, camera 105a is coupled to local computer 110a, camera 105b is coupled to local computer 110b, and camera 105n is coupled to local computer 110n. Video is transmitted at 210 from each camera 105 to a corresponding local computer 110 at the known location coupled to or integrated with the camera. In one embodiment, the webcams are generally connected by a USB cable, or similar cable, or built into computer hardware, such as a laptop, notebook, handheld computer, or smartphone. In one embodiment, local computer 110a, 110b and 110n are low-cost, high-performance computers, such as those available from the Raspberry Pi Foundation. In another embodiment, the local computer is a smartphone set up as a mobile hotspot to obtain Internet access.

When captured by the local computer, the video stream may be saved, viewed, and/or sent on to other computers, such as a laptop, notebook, handheld computer, or smartphone, or networks, via communication systems such as the Internet, and/or via electronic mail, as an attachment. In one embodiment, the local computer 110 at the known location receives a request 215 for a video stream, or for some number of frames of visual images from the video stream, and in response thereto, a software application executing on the local computer at the known location obtains or extracts at 220 frames of visual images from the video stream. In one embodiment, the request may be for a specific number of frames. Alternatively, the request may specify obtaining a video stream obtained over a preset time interval or a number of frames obtained over a preset time interval. For example, the request may specify a segment of video stream that spans a time period, such as the most recent 5 seconds, the most recent 10 seconds, or a specific window of time, such as 7:00:00 PM-7:00:10 PM, of video stream captured by the local computer. In such case, the number of frames extracted may depend on the frame rate of the video stream generated by the webcam, and/or the frame rate extracted by the local computer. Frame rate, also known as frame frequency, is the frequency or rate at which the webcam, or any imaging device, produces consecutive images called frames, and is usually expressed in frames per second (FPS). In one embodiment, it is contemplated the webcam records or produces video at a certain frame rate, and the local computer may extract video at the same frame rate, or a slower frame rate. So, for example, if the webcam captures video at 30 FPS and transfers the video stream to the local computer, the local computer can extract up to 30 FPS, or might, for example, extract every 6th frame to produce a 5 FPS video feed in response to the request, depending on such factors as the desired quality of video stream, storage constraints, communication bandwidth, etc. As an example, if the request is for 10 seconds of video stream, then the local computer might extract somewhere between 50 to 300 frames of video.

Importantly, a webcam typically generates video that adheres to a well known video format, such as MPEG (Moving Pictures Experts Group, an audio and video compression and transmission standard with the official designation of ISO/IEC JTC 1/SC 29/WG 11), MPEG Dash (MPEG Dynamic Adaptive Streaming over HTTP, a standard designated as ISO/IEC 23009-1), or HLS (Hypertext TTP Live Streaming, implemented by Apple Inc. as part of its QuickTime, Safari, OS X and iOS software). However, there is no official or de facto standard among current browser software applications for retrieving and presenting a video stream over the World Wide Web (“the Web”). Furthermore, depending on the application context, there may be no need to deliver an actual, real-time, high FPS, video stream over the Web to an end user device, such as a smartphone, so that it can be viewed in a browser application executing on the end user device. It may be sufficient (and take far less communications bandwidth) to provide some subset of frames of visual images extracted from the video stream. In doing so, it may be necessary or appropriate to convert those frames to a format that most browser software applications recognize and can process, such as the JPEG format (Joint Photographic Experts Group, a compression standard for digital photographic images). Thus, there may be a need to convert the video stream, whether formatted according to MPEG, MPEG Dash, HLS, or some other video stream formatting standard, to a different digital format such as JPEG, and transmit a series of JPEG images to a browser application executing on an end user device, which, when displayed in sufficiently rapid succession, gives the impression of a “playing” a video stream, without the need for a video player plug-in software application executing on the end user device.

In an embodiment of the invention, this translation or conversion of the video stream, formatted according to a video compression standard, into a series of frames of visual information taken from the video stream and formatted according to a digital photographic compression standard, takes place in a decentralized manner, so as not to create a computational bottleneck at a central server or cloud computing platform. In particular, each co-located computer 110a, 110b, and 110n, executes translation software that converts the video stream received from a corresponding webcam 105a, 105b, and 105n, and formatted according to a video compression standard, into the series of frames formatted according to a digital photographic compression standard. In one embodiment, the translation software is FFmpeg, a multimedia framework that is able to decode, encode, transcode, mux, demux, stream, filter and play a wide range of video formats, and can be executed on computing platforms operating under operating systems including Linux, Mac OS X, Microsoft Windows, and Solaris.

In one embodiment, translation of the webcam video to a series of frames—such as JPEG digital photographic images—occurs at the co-located computer automatically and the series of JPEG digital photographic images are stored at the local computer. In another embodiment, the webcam video is stored on the co-located computer, and a portion thereof is translated to a series of frames in response to the local computer receiving the request for a segment of video, e.g., a request for a number of frames of visual images from the video, at 215. Thus, translation only occurs when there is a need to do so, that is, when a request for a sequence of frames of the video stream is received.

Given memory and storage constraints at the local computer, some finite amount of video content may be stored, such as the most recent 30 minutes of video generated at the known location, and only a fraction of such may be translated and extracted at 220 in response to the request 215. It may be that multiple requests for the same segment of video stream are received, in which case, the translation of such segment is performed only once, upon receiving the first request, and the translated segment is stored as a series of JPEG formatted digital photographic images, ready to be provided in response to subsequent requests from different end user devices.

According to an embodiment of the invention, once the frames of video are extracted at 220 in response to the receiving the request for the video, the local computer 110 transmits the frames at 225 from the computer 110 to a server 115 coupled to the computer via a communications network, such as the Internet. Since the frames have already been translated into a format that most browsers can recognize, there is no need for translation to occur at the server. The server need only forward the sequence of frames from the server to a specific browser. In the embodiments of the invention, there is any number of end user devices 120a, 120b, . . . 120n, whether personal computers, laptops, notebook computers, or smartphones, that execute a web browser software application such as Safari, developed by Apple Inc., Chrome, developed by Google, or Firefox, developed by the Mozilla Foundation and the Mozilla Corporation. Any one of these browsers can receive and display on a display screen of the end user device the series of JPEG formatted digital photographs in the stream or sequence of frames so that an end user operating the end user device can see what is happening at the restaurant, bar, venue or other event location over the period of time from which the sequence of frames was generated, without the need for a video display plug-in software component in order to play the video stream on the end user's device display screen. In one embodiment, the server 115 transmits the frames of visual images to one or more of end user devices 120a, 120b, . . . 120n.

In one embodiment, the request for video received at a local computer 110 at step 215 is responsive to receiving input at the browser application executing on the end user device to view the known location. For example, if a user operating end user device 120a wants to see what is happening at a known location, such as a restaurant at which webcam 105b is located, the user might type in the name of the known location, press a button, tap a location on a map displayed on the display screen, or enter a selection from a list of known locations displayed on the display screen, indicating that location. The input is received by the end user device's browser software application. A request is then generated by the browser software application and transmitted to server 115. The server, in turn, according to one embodiment, transmits the request for a video stream to local computer 110b on behalf of the request received from end user device 120a. Alternatively, the server simply forwards to computer 110b the request from the browser software application when it is received at the server 115. The server, or a network gateway, router, or switch providing networking and routing services for or to the server, executes software to access and maintains in appropriate storage coupled to or otherwise accessible to the server, gateway, router, or switch, the network address or destination of the local computer associated with the known location for which video is requested, so that the server, gateway, router, or switch, can transmit the request, or forward the browser's request, when the browser's request is received at the server. Likewise, the server, gateway, router, or switch, keeps track of the network address or source of the request, that is, the end user device, so that when a reply to the request is received from the local computer it can be routed to the end user device.

At step 230, the local computer 110b responds to the request for video and transmits in reply at 230 the frames of visual images to the end user device 120a. In one embodiment, the frames are transmitted via the server 115, which can then maintain its own store of the frames and operate as a proxy for the local computer 110b in responding to any subsequent requests from the same or different end user devices for the same set of frames of visual images. Alternatively, the frames may be transmitted to the end user device according to optimized internetwork networking and/or routing protocols that select a better/faster/cheaper route via which to forward the frames to the end user device, depending on such network operational parameters such as communication bandwidth constraints, latency, etc.

In one embodiment, for example, for security purposes and/or to prevent one user dominating access to the video stream generated by a particular webcam 105, the request for video is responsive to receiving input at the browser application executing on the end user device to view the known location not more than twice within a specified time period. In one embodiment, for example, a user is able to view up to 10 seconds of video from a known location, two times within a first set period of time, such as 2 minutes. If the user has requested a video stream twice within the set period of time, the user is prevented from further requesting, via application software executing on the end user device that blocks such request, or via application software executing at the server 115, or any subsequent request is ignored, for a second set period of time, such as an additional 2 minutes.

Finally, at step 235, the frames transmitted to the end user device may be displayed, consecutively, on the electronic visual display device coupled to or integrated with the end user computing device, such as the display screen on a smart phone.

Some portions of this detailed description are presented in terms of algorithms and representations of operations on data within a computer memory. These algorithmic descriptions and representations are the means used by those skilled in the data processing arts to most effectively convey the substance of their work to others skilled in the art. An algorithm is here, and generally, conceived to be a sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from this discussion, it is appreciated that throughout the description, discussions utilizing terms such as “processing” or “computing” or “calculating” or “determining” or “displaying” or the like, refer to the action and processes of a computer system or computing platform, or similar electronic computing device(s), that manipulates and transforms data represented as physical (electronic) quantities within the computer system's registers and memories into other data similarly represented as physical quantities within the computer system memories or registers or other such information storage, transmission or display devices.

Embodiments of invention also relate to apparatuses for performing the operations herein. Some apparatuses may be specially constructed for the required purposes, or may comprise a general purpose computer(s) selectively activated or configured by a computer program stored in the computer(s). Such a computer program may be stored in a computer readable storage medium, such as, but not limited to, any type of disk including optical disks, CD-ROMs, DVD-ROMs, and magnetic-optical disks, read-only memories (ROMs), random access memories (RAMs), EPROMs, EEPROMs, NVRAMs, magnetic or optical cards, or any type of media suitable for storing electronic instructions, and each coupled to a computer system bus.

The algorithms presented herein are not inherently related to any particular computer or other apparatus. Various general purpose systems may be used with programs in accordance with the teachings herein, or it may prove convenient to construct more specialized apparatus to perform the required methods. The structure for a variety of these systems appears from the description herein. In addition, embodiments of the invention are not described with reference to any particular programming language. It will be appreciated that a variety of programming languages may be used to implement the embodiments of the invention as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices, etc.

Although the invention has been described and illustrated in the foregoing illustrative embodiments, it is understood that the present disclosure has been made only by way of example, and that numerous changes in the details of implementation of the invention can be made without departing from the spirit and scope of the invention, which is only limited by the claims that follow. Features of the disclosed embodiments can be combined and rearranged in various ways.

What is claimed is:

1. A method for displaying visual images transmitted electronically to an electronic visual display device, comprising:
generating a video via a digital video camera positioned at a known location;
transmitting the video from the digital video camera to a computer at the known location coupled to or integrated with the digital video camera;
receiving at the computer at the known location a request for a plurality of frames of visual images from the video, and in response thereto:
obtaining the plurality of frames from the video via a software application executing on the computer at the known location, each of the plurality of frames obtained at a preset time interval;
transmitting the plurality of frames from the computer at the known location to a server coupled to the computer via a communications network;
transmitting the plurality of frames from the server to an end user computing device coupled to the server via the communications network, wherein the request for the plurality of frames of visual images from the video is responsive to receiving input at a browser application executing on the end user device to view the known location; and
displaying, consecutively, the plurality of frames on an electronic visual display device coupled to or integrated with the end user computing device.

2. The method of claim 1, wherein receiving at the computer at the known location the request for a plurality of frames of visual images from the video comprises receiving the request from the server.

3. The method of claim 2, wherein receiving input at a browser application executing on the end user device to view the known location comprises receiving input at the browser application from an end user operating the end user device;
the method further comprising transmitting the input from the browser application to the server; and
wherein receiving the request from the server is responsive to receiving at the server the input transmitted from the browser application.

4. The method of claim 1, wherein obtaining the plurality of frames from the video via a software application executing on the computer at the known location, each of the plurality of frames obtained at a preset time interval, comprises obtaining the plurality of frames at a frame rate corresponding to the preset time interval.

5. The method of claim 4, wherein displaying, consecutively, the plurality of frames on an electronic visual display device coupled to or integrated with the end user computing device comprises displaying the plurality of frames for a limited period of time.

6. The method of claim 1, wherein transmitting the plurality of frames from the server to the end user computing device coupled to the server via the communications network comprises transmitting the plurality of frames from the server to the end user computing device, wherein the request for the plurality of frames of visual images from the video is responsive to receiving input at the browser application executing on the end user device to view the known location not more than twice within a specified time period.

7. A non-transitory computer-readable medium containing computer-executable instructions that, when executed by a processor, cause the processor to display visual images transmitted electronically to an electronic visual display device, according to a method comprising:
generating a video via a digital video camera positioned at a known location;
transmitting the video from the digital video camera to a computer at the known location coupled to or integrated with the digital video camera;
receiving at the computer at the known location a request for a plurality of frames of visual images from the video, and in response thereto:
obtaining the plurality of frames from the video via a software application executing on the computer at the known location, each of the plurality of frames obtained at a preset time interval;
transmitting the plurality of frames from the computer at the known location to a server coupled to the computer via a communications network;
transmitting the plurality of frames from the server to an end user computing device coupled to the server via the communications network, wherein the request for the plurality of frames of visual images from the video is responsive to receiving input at a browser application executing on the end user device to view the known location; and
displaying, consecutively, the plurality of frames on an electronic visual display device coupled to or integrated with the end user computing device.

8. The non-transitory computer-readable medium of claim 7, wherein receiving at the computer at the known location the request for a plurality of frames of visual images from the video comprises receiving the request from the server.

9. The non-transitory computer-readable medium of claim 8, wherein receiving input at a browser application executing on the end user device to view the known location comprises receiving input at the browser application from an end user operating the end user device;
the method further comprising transmitting the input from the browser application to the server; and
wherein receiving the request from the server is responsive to receiving at the server the input transmitted from the browser application.

10. The non-transitory computer-readable medium of claim, wherein obtaining the plurality of frames from the video via a software application executing on the computer at the known location, each of the plurality of frames obtained at a preset time interval, comprises obtaining the plurality of frames at a frame rate corresponding to the preset time interval.

11. The non-transitory computer-readable medium of claim 10, wherein displaying, consecutively, the plurality of frames on an electronic visual display device coupled to or integrated with the end user computing device comprises displaying the plurality of frames for a limited period of time.

12. The non-transitory computer-readable medium of claim 7, wherein transmitting the plurality of frames from the server to the end user computing device coupled to the server via the communications network comprises transmitting the plurality of frames from the server to the end user computing device, wherein the request for the plurality of frames of visual images from the video is responsive to receiving input at the browser application executing on the end user device to view the known location not more than twice within a specified time period.
